(19) United States
(12) Patent Application Publication
(10) Pub. No.: US 2022/0042650 A1
(43) Pub. Date: Feb. 10, 2022

(54) GAS SUPPLY APPARATUS

(71) Applicant: KABUSHIKI KAISHA KOBE SEIKO SHO (KOBE STEEL, LTD.), Hyogo (JP)

(72) Inventors: Daisuke WADA, Takasago-shi (JP); Akira MATSUOKA, Kobe-shi (JP); Naofumi KANEI, Takasago-shi (JP)

(73) Assignee: KABUSHIKI KAISHA KOBE SEIKO SHO (KOBE STEEL, LTD.), Hyogo (JP)

(21) Appl. No.: 17/375,776

(22) Filed: Jul. 14, 2021

(30) Foreign Application Priority Data
Aug. 7, 2020 (JP) 2020-134474

(51) Int. Cl. F17C 7/00; F17C 13/12

(52) U.S. Cl. CPC F17C 7/00; F17C 13/12; F17C 2221/012; F17C 2227/0157; F17C 2270/0763; F17C 2223/036; F17C 2225/0123; F17C 2265/065; F17C 2223/0123

(57) ABSTRACT

The gas supply apparatus is installed in a site of a facility for replenishing hydrogen gas. The gas supply apparatus includes: a gas treatment unit for treating the hydrogen gas; a housing including a gas unit accommodation part fix accommodating the gas treatment unit; and a duct part for allowing the air to flow out of or into the gas unit accommodation part. The housing includes a side section and a top section each having a barrier member. The duct part includes an inner opening section opened horizontally to the gas unit accommodation part, a passage section joining the inner opening section, and an outer opening section causing the passage section to open to an outside of the housing. The duct part has a barrier member.

### TECHNICAL FIELD

The present invention relates to a gas supply apparatus to be installed in a site of a facility for replenishing hydrogen gas.

### BACKGROUND ART

Conventionally, as disclosed in Japanese Unexamined Patent Publication No. 2019-27587 and Japanese Unexamined Patent Publication No. 2019-90501, a gas supply apparatus to be installed in a site of a facility for replenishing hydrogen gas has been known. In the gas supply apparatus disclosed in Japanese Unexamined Patent Publication No. 2019-27587, a part of a housing for accommodating a gas treatment unit for treating hydrogen gas is composed of a barrier member. On the other hand, in the gas supply apparatus disclosed in Japanese Unexamined Patent Publication No. 2019-90501, a support member for fixing a barrier wall is attached to a housing for accommodating an equipment for treating hydrogen gas.

In the gas supply apparatuses disclosed in Japanese Unexamined Patent Publication No. 2019-27587 and Japanese Unexamined Patent Publication No. 2019-90501, a reward that an excessive cost is suppressed to provide barrier walls can be obtained. However, these documents have not taken into consideration explosion venting.

### SUMMARY OF INVENTION

An object of the present invention is to provide a gas supply apparatus having a configuration which makes it possible to vent explosion while preventing the cost required for a barrier structure from becoming excessive.

A gas supply apparatus according to one aspect of the present invention is a gas supply apparatus to be installed in a site of a facility for replenishing hydrogen gas, and is provided with: a gas treatment unit for treating the hydrogen gas; a housing including a gas unit accommodation part for accommodating the gas treatment unit; and a duct part for allowing the air to flow out of or into the gas unit accommodation part. The housing includes side sections and a top section each having a barrier member. The duct part includes an inner opening section opened horizontally to the gas unit accommodation part, a passage section joining the inner opening section, and an outer opening, section causing the passage section to open to an outside of the housing, and the duct part has a barrier member.

### BRIEF DESCRIPTION OF DRAWINGS

FIG. 1 is a perspective view of a gas supply apparatus according to an embodiment.

FIG. 2 is a perspective view of a gas supply apparatus according to a first modified embodiment.

FIG. 3 is a perspective view of a gas supply apparatus according to a second modified embodiment.

FIG. 4 is a perspective view of a gas supply apparatus according to a third modified embodiment.

FIG. 5 is a perspective view of a gas supply apparatus according to a fourth modified embodiment.

FIG. 6 is a perspective. view of a gas supply apparatus according to a fifth modified embodiment.

FIG. 7 is a perspective view of a gas supply apparatus according to a sixth modified embodiment.

FIG 8 is a perspective view of a gas supply apparatus according to a seventh modified embodiment.

### DESCRIPTION OF EMBODIMENTS

Hereinafter, an embodiment will be described in detail with reference to the drawings.

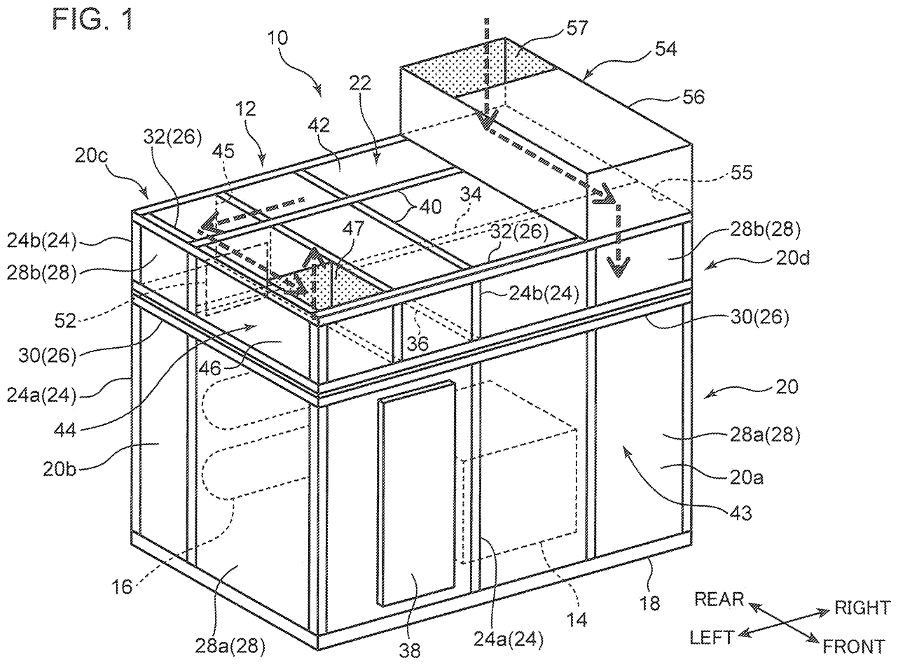

As shown in FIG. 1, a gas supply apparatus 10 according to the present embodiment is installed in a facility for replenishing hydrogen gas, for example, a site of a hydrogen station, and is configured to supply hydrogen gas having a high pressure to a dispenser outside the drawing. The dispenser supplies hydrogen gas to a fuel cell vehicle which is a tank mounted apparatus.

The gas supply apparatus 10 is provided with a housing 12 for accommodating a gas treatment unit for treating hydrogen gas. The gas system is provided with, for example, a compression mechanism 14 that compresses hydrogen gas, and an accumulator 16 that stores the hydrogen gas compressed by the compression mechanism 14. For example, the accumulator 16 can store hydrogen gas having a pressure of 80 MPa or more.

The housing 12 includes a bottom section 18, a peripheral wall 20 arranged along an outer peripheral edge of the bottom section 18, and a ceiling 22 connected to an upper end of the peripheral wall 20.

The bottom section 18 includes a frame assembly formed by combining a plurality of frames in a rectangular shape juxtaposed in a front-rear direction and a left-right direction, the bottom section 18 being in a rectangular shape. A plate may be arranged over the frame assembly. The bottom section 18 is fixedly held on, for example, a concrete foundation.

The peripheral wall 20 includes a front section 20a which lies along a front side of the bottom section 18, a left section 20b which lies along a left side of the bottom section 18, a rear section 20c which lies along a rear side of the bottom section 18, and a right section 20d which lies along a right side of the bottom section 18. Specifically, the peripheral wall 20 has four side sections.

The peripheral wall 20 includes a plurality of columns 24, a plurality of beams 26 bridged across the columns 24, and a plurality of side plates 28 fixedly attached to the plurality of columns 24 and the plurality of beams 26. The front section 20a, the left section 20b, the rear section 20c, and the right section 20d of the peripheral wall 20 each include columns 24, beams 26, and side plates 28.

The plurality of columns 24 are arranged at intervals in a peripheral edge portion of the bottom section 18. Specifically, the columns 24 include four columns (corner columns) 24 arranged at four corners of the bottom section 18, and at least four columns (intermediate columns) 24 arranged at intermediate portions of the front side, the rear side, the left side and the right side of the bottom section 18, respectively.

Each column 24 includes a lower column 24a standing on the bottom section 18, and an upper column 24b located above the lower column 24a. The upper column 24b stands on an intermediate beam 30 to be described later.

The beams 26 include intermediate beams 30 and upper beams 32. The intermediate beams 30 are connected to upper ends of the plurality of lower columns 24a or intermediate portions of the columns 24 to stay between the plurality of lower columns 24a. The upper beams 32 are connected to upper ends of the plurality of upper columns 24b or upper ends of the columns 24 to stay between the plurality of upper columns 24b. The intermediate beams 30 and the upper beams 32 respectively include a front beam located on the front side of the bottom section 18, a rear beam (not shown) located on the rear side of the bottom section 18, a left beam located on the left side of the bottom section 18, and a right beam (not shown) located on the right side of the bottom section 18.

The housing 12 is provided with a first beam 34 and a second beam 36. The first beam 34 is a beam extending in the housing 12, and has an end connected to an intermediate portion of the left beam (intermediate beam 30), and the other end connected to an intermediate portion of the right beam (intermediate beam 30). The second beam 36 is a beam extending in a direction orthogonal to the first beam 34 in the housing 12, and has an end connected to an intermediate portion of the front beam (intermediate beam 30), and the other end connected to an intermediate portion of the rear beam (intermediate beam 30).

The side plate 28 is made of a sheet material, and is arranged so as to close rectangular spaces defined by the bottom section 18, adjacent columns 24, and beams 26.

The side plate 28 includes a lower side plate 28a and an upper side plate 28b. The lower side plates 28a are arranged so as to close rectangular spaces defined by the bottom section 18, adjacent lower columns 24a, and intermediate beams 30, and are fixedly attached to the bottom section 18, the lower columns 24a, and the intermediate beams 30. The upper side plates 28b are arranged so as to close rectangular spaces defined by intermediate beams 30, adjacent upper columns 24b, and upper beams 32, and are fixedly attached to the intermediate beams 30, the upper columns 24b, and the upper beams 32. The lower side plates 28a and the upper side plates 28b include a front side plate arranged on the front section 20a of the peripheral wall 20, a left side plate arranged on the left section 20b of the peripheral wall 20, a rear side plate arranged on the rear section 20c of the peripheral wall 20, and a right side plate arranged on the right section 20d of the peripheral wall 20.

The peripheral wall 20 is provided with a door 38 for accessing the gas treatment unit. A steel plate equivalent to those of the other portions of the housing 12 is used for the door 38, and in this embodiment, the door 38 functions as a substantial barrier member. The peripheral wall 20 may be provided with no door 38.

The ceiling 22 constitutes a top section of the housing 12, and includes ceiling beams 40 and ceiling plates 42.

The ceiling beam 40 is made of a beam material connecting intermediate portions of upper beams 32 to each other, and includes a front-rear beam connecting an intermediate portion of the front beam and an intermediate portion of the rear beam, and a left-right beam connecting an intermediate portion of the left beam and an intermediate portion of the right beam.

The ceiling plate 42 is made of a rectangular sheet material arranged so as to close a rectangular space defined by upper beams 32. The ceiling plate 42 has a front side joined to an upper edge of the front section 20a in the peripheral wall 20 or the front beam of the upper beams 32. The ceiling plate 42 has a left side joined to an upper edge of the left section 20b in the peripheral wall 20 or the left beam of the upper beams 32. The ceiling plate 42 has a rear side joined to an upper edge of the rear section 20c in the peripheral wall 20 or the rear beam of the upper beams 32, and a right side joined to an upper edge of the right section 20d in the peripheral wall 20 or the right beam of the upper beams 32.

The side sections (peripheral wall 20) of the housing 12 each are made of a barrier member. Specifically, the front section 20a, the left section 20b, the rear section 20e, and the right section 20d of the peripheral wall 20 are made of barrier members, respectively. Since the side plate 28 constituting the side section of the housing 12 is made of a steel plate having a thickness of 6 mm or more, it can be said that the side sections of the housing 12 are made of barrier members. However, the barrier member is not limited to this configuration. For example, the side plate 28 may be made of a steel sheet having a thickness of 3.2 mm or more. In this configuration, reinforcing members or isosceles triangle steel pieces of 30×30 mm or more may be welded to the side plate 28 at an interval of 40 cm or less in longitudinal and lateral directions to reinforce the side plate 28.

The top section of the housing 12 is made of a barrier member. Specifically, the plate (ceiling plate 42) constituting the ceiling 22 is made of a steel plate having a thickness of 6 mm or more. However, the present invention is not limited to this configuration. The ceiling plate 42 may be made of a steel sheet having a thickness of, for example, 12 mm or more. In this configuration, reinforcing members or isosceles triangle steel pieces of 30×30 mm or more may be welded to the plate at an interval of 40 cm or less in longitudinal and lateral directions to reinforce the plate (ceiling plate 42).

A duct part 44 is arranged in an inside of the housing 12. Specifically, the housing 12 includes a gas unit accommodation part 43 for accommodating the gas treatment unit, and a duct part 44 for allowing the air in the gas unit accommodation part 43 to flow to the outside of the housing 12. The duct part 44 is arranged along a connection portion between the ceiling 22 and a side section (left section 20b in the illustrated embodiment) in the housing 12. Thus, the duct part 44 has a top portion constituted by a part of the ceiling 22 of the housing 12, and an outer side portion constituted by a part of the side section (left section 20b) of the housing 12.

The duct part 44 is formed into a hollow rectangular parallelepiped shape, and includes an inner opening section 45 opened to the gas unit accommodation part 43, a passage section 46 joining the inner opening section 45, and an outer opening section 47 causing the passage section 46 to open to an outside of the housing 12. The inner opening section 45 is constituted of a rectangular frame body defining a rectangular opening, and is located in the housing 12. The inner opening section 45 opens horizontally to the gas unit accommodation part 43. The outer opening section 47 is constituted of a rectangular frame body defining a rectangular opening, and opens upward to the outside of the housing 12 on the top section of the housing 12.

The rectangular frame body constituting the inner opening section 45 includes a pair of vertical members, an upper lateral member connecting upper ends of the pair of vertical members, and a lower lateral member connecting lower ends of the pair of vertical members. One of the pair of vertical members is constituted by an upper column 24b of an intermediate column 24 (intermediate column 24 connected to an intermediate portion of the rear beam). The upper lateral member is constituted by a portion of a ceiling beam 40 (front-rear beam). The inner opening section 45 opens horizontally to the gas unit accommodation part 43 (in the left-right direction). Specifically, the inner opening section 45 opens horizontally in a direction orthogonal to a longitudinal direction of the duct part 44.

The passage section 46 of the duct part 44 has a shape extending in the front-rear direction, and extends from the front section 20a to the rear section 20c of the housing 12. Specifically, the passage section 46 extends in a direction different from an opening direction of the inner opening section 45. Therefore, the gas treatment unit is hidden by the duct part 44 to be invisible from outside through the outer opening section 47.

The passage section 46 includes an outer side portion extending horizontally (in the front-rear direction in the illustrated embodiment) while having a predetermined width in a vertical direction, an inner side portion which extends parallel to the outer side portion and is located inside the housing 12, a top portion constituted by a part of the ceiling 22 of the housing 12, and a bottom portion which extends parallel to the top portion and is located inside the housing 12.

The rectangular frame body constituting the outer opening section 47 partially utilizes a part of the upper beams 32 extending in the front-rear direction, a part of upper beams 32 extending in the left-right direction, and a part of the ceiling beams 40 extending in the front-rear direction, respectively. The outer opening section 47 opens upward in the top section of the housing 12.

The inner opening section 45 and the outer opening section 47 have respective opening areas (i.e., cross-sectional areas perpendicular to the duct part extending direction of the passage section 46 of the duct part 44) which are required to be broader than a value calculated according to a method described in National Fire Protection Association (NI PA) Codes and Standards No. 68: Standard On Explosion Protection by Deflagration Venting. The same applies to a second duct part 54 which will be described later and the other embodiments.

The duct part 44 is made of a barrier member. Specifically, the passage section 46 of the duct part 44 is made of a steel plate having a thickness of 6 mm or more. However, the present invention is not limited to this configuration. For example, the plate constituting the passage section 46 may be made of a steel sheet having a thickness of 3.2 mm or more. In this configuration, reinforcing members or isosceles triangle steel pieces of 30×30 mm or more may be welded to the plate of the passage section 46 at an interval of 40 cm or less in longitudinal and lateral directions to reinforce the plate.

A blower 52 (ventilation fan) is arranged in an inside of the duct part 44. When the blower 52 operates, the air in the gas unit accommodation part 43 is suctioned into the duct part 44. Accordingly, the air in the gas unit accommodation part 43 is exhausted to the outside through the duct part 44. The blower 52 may be omitted.

The top portion and the side portions of the duct part 44 serve as the top section and the side sections of the housing 12. respectively. Therefore, a portion of the barrier member constituting the duct part 44 serves as a portion of the barrier member constituting the housing 12.

The housing 12 is provided with another duct part (second duct part) 54 on the top section thereof. The second duet part 54 allows the air (outside air) to flow into the gas unit accommodation part 43.

The second duct part 54 includes an inner opening section 55 opened downward to the gas unit accommodation part 43, an outer opening section 57 opened upward, and a passage section 56 connecting the inner opening section 55 and the outer opening section 57. An opening is defined in the ceiling 22 of the housing 12, and the inner opening section 55 of the second duct part 54 opens to the opening.

The passage section 56 extends in the front-rear direction from the inner opening section 55 disposed in conformity with the opening in the housing 12. Specifically, the passage section 56 extends in a direction different from the opening direction of the inner opening section 55. The outer opening section 57 is provided on the other end side of the passage section 56. The outer opening section 57 opens upward. Therefore, the gas treatment unit is hidden by the second duct part 54 to be invisible from outside through the outer opening section 57.

The second duct part 54 is made of a barrier member, Specifically, the second duct part 54 is made of a steel plate having a thickness of 6 mm or more. However, the present invention is not limited to this configuration. For example, the plate constituting the second duct part 54 may be made of a steel sheet having a thickness of 3.2 mm or more. In this configuration, reinforcing members or isosceles triangle steel pieces of 30×30 mm or more may be welded to the plate of the second duct part 54 at an interval of 40 cm or less in longitudinal and lateral directions to reinforce the plate.

A refrigerator housing (not shown) for accommodating refrigeration system may be connected to the housing 12. For example, the refrigerator housing may be provided adjacent to the right section 20d of the housing 12 so as to be integral with the housing 12. In this case, the refrigerator housing is not necessarily required to have a barrier structure.

As described above, in the present embodiment, both the gas unit accommodation part 43 and the duct part 44 are made of a barrier member to have a configuration where both explosion-proof and explosion venting can be achieved. Further, since the inner opening section 45 of the duct part 44 opens horizontally to the gas unit accommodation part 43, it is possible to suppress generation of gas retention in the gas unit accommodation part 43.

In the present embodiment, since the duct part 44 is provided in an inside of the housing 12, the duct part 44 does not project to the rooftop, and a working space on the top section of the housing 12 can be secured. The gas supply apparatus 10 can be made compact.

In the present embodiment, the passage section 46 extends in a direction different from the opening direction of the inner opening section 45 in the duct part 44. Therefore, even if the length of the duct part 44 is shortened, the gas treatment unit can be hardly seen through the outer opening section 47,

In the present embodiment, the outer opening section 47 opens upward on the top section of the housing 12. Therefore, since the duct part 44 does not project from the top section and the side sections of the housing 12, the dimensions in a height direction or the lateral direction of the housing 12 can be suppressed.

In the present embodiment, the gas treatment unit is hidden by the duct part 44 to be invisible from outside through the outer opening section 47. Therefore, the whole gas treatment unit is shielded from the site boundary, so that the configuration is in conformity with The General High Pressure Gas Safety Ordinance.

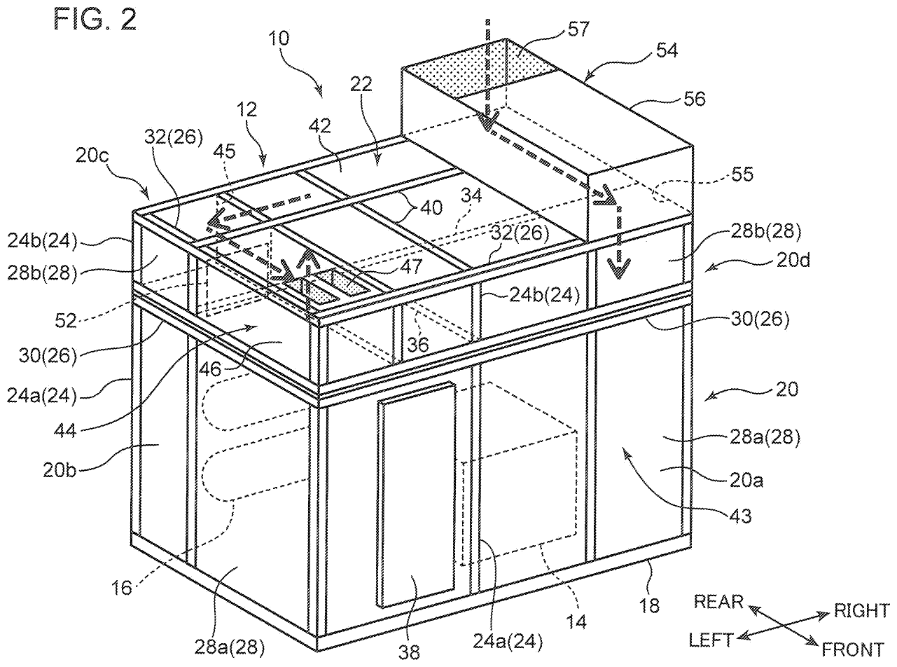

It is to be understood that the presently disclosed embodiments are illustrative and not restrictive in all respects. The present invention is not limited to the above-described embodiments, and various changes and modifications can be made without departing from the gist of the invention. For example, in the embodiment, the outer opening section 47 of the duct part 44 defines one opening, but is not limited thereto. As shown in FIG. 2, the outer opening section 47 may define a plurality of (two in the illustrated embodiment) openings. The inner opening section 45 may also define a plurality of openings. The same applies to the second duct part 54.

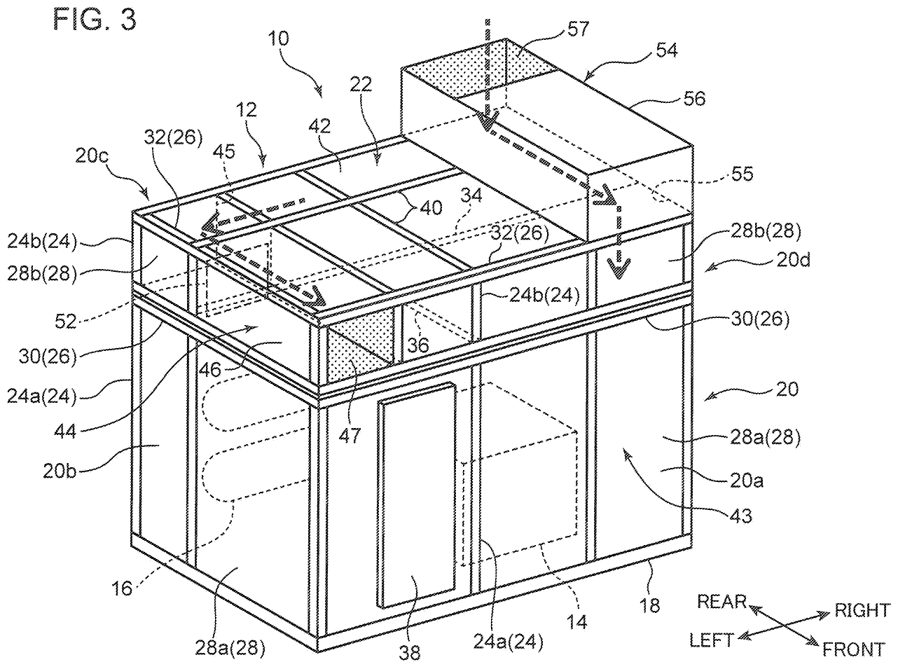

In the embodiment, the outer opening section 47 of the duct part 44 opens upward in the ceiling 22 of the housing 12, but is not limited thereto. As shown in FIG. 3, the outer opening section 47 of the duct part 44 may open horizontally on the side section of the housing 12.

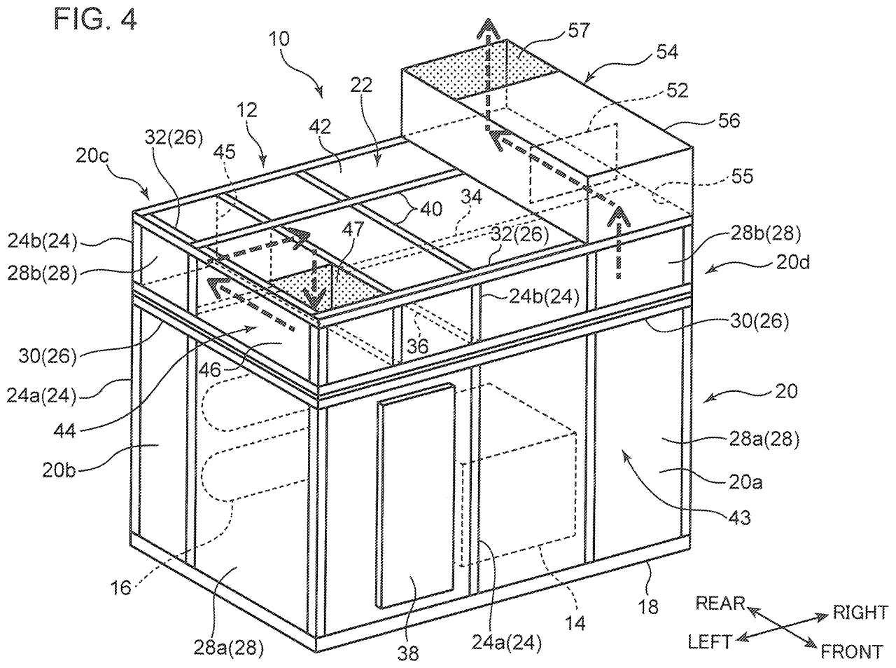

In the embodiment, the duct part 44 is configured to discharge air from the gas unit accommodation part 43, but is not limited thereto. As shown in FIG. 4, the duct part 44 may be configured to take outside air into the gas unit accommodation part 43. In this case, the second duct part 54 is configured to discharge air from the gas unit accommodation part 43, and the blower 52 may be arranged in the second duct part 54.

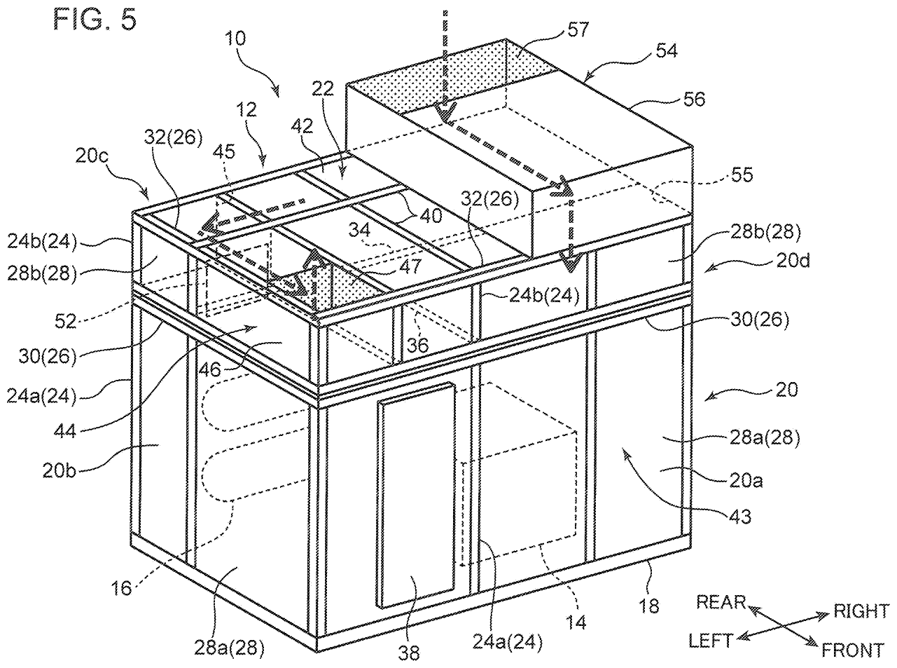

In the embodiment, the width of the second duct part 54 is the same as the width of the duct part 44, and the outer opening section 57 and the inner opening section 55 of the second duct part 54 are formed in the same size as the outer opening section 47 and the inner opening section 45 of the duct part 44, but are not limited thereto. As shown in FIG. 5, the width of the second duct part 54 may be greater than the width of the duct part 44. Specifically, the outer opening section 57 and the inner opening section 55 of the second duct part 54 may be larger than the outer opening section 47 and the inner opening section 45 of the duct part 44. The second duct part 54 may be omitted.

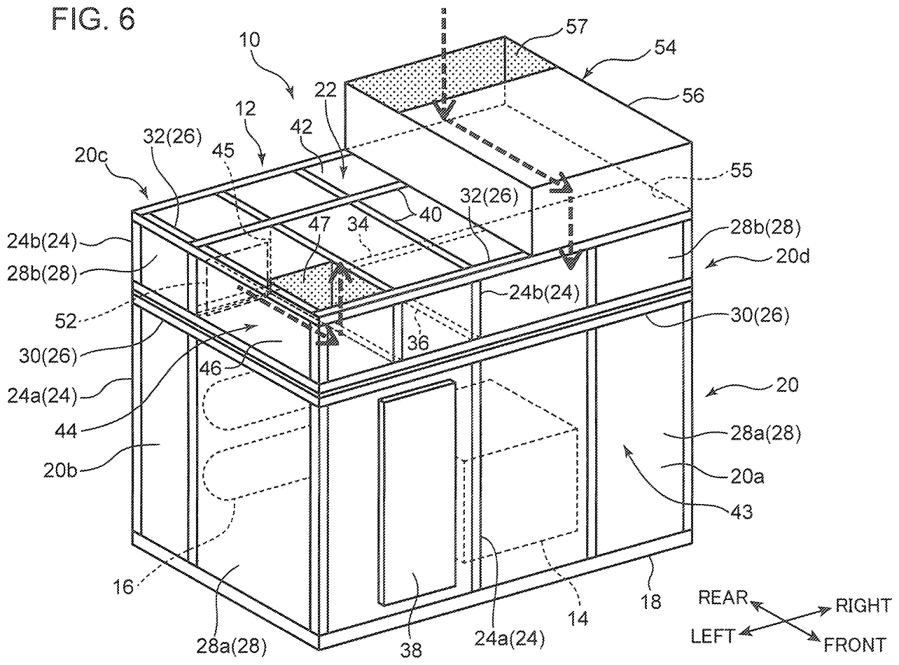

In the embodiment, the duct part 44 is formed to have a length extending from the front section 20a to the rear section 20c of the housing 12, but is not limited thereto. As shown in FIG. 6, the duct part 44 may be formed to be shorter than a distance between the front section 20a and the rear section 20c of the housing 12. In this case, the inner opening section 45 of the duct part 44 opens to the side section (rear section 20c) of the housing 12 at a position away from the side section (rear section 20c). Specifically, the inner opening section 45 opens in the longitudinal direction of the duct part 44. FIG. 6 shows a configuration where the second duct part 54 is formed to be wider than the duct part 44, but the second duct part 54 may have the same width as that of the duct part 44.

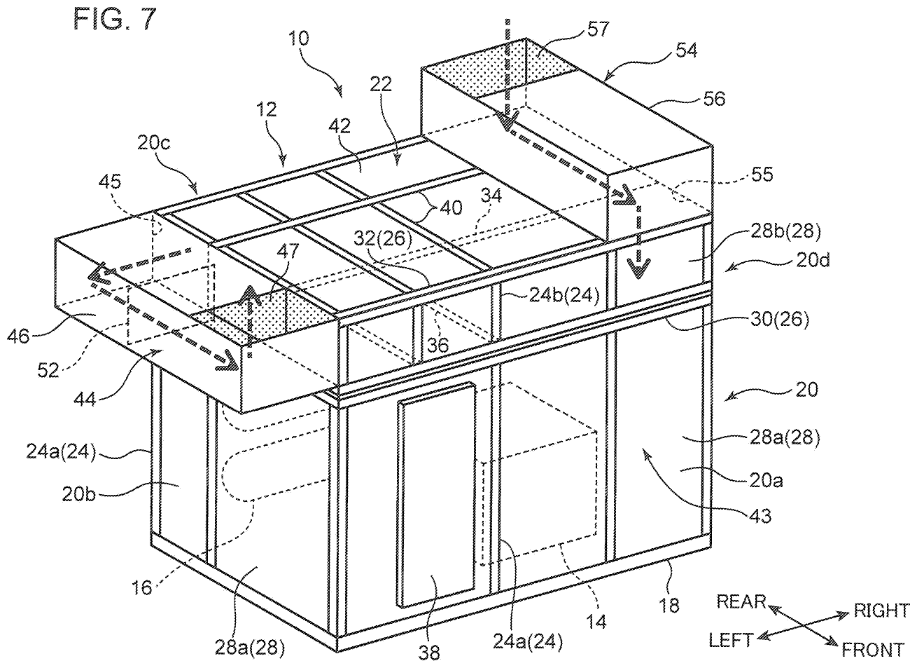

In the embodiment, the duct part 44 is provided in an inner side of the housing 12, but is not limited thereto. As shown in FIG. 7, the duct part 44 may be provided in an outer side of the housing 12 so as to be adjacent to the housing 12. In this configuration, the entire housing 12 serves as a gas unit accommodation part 43. In this case, since the duct part 44 is adjacent to the housing 12 and is not limited to the dimensions of the housing 12, the outer opening section 47 can be formed to be larger.

The duct part 44 in this case is also made of a barrier member. One side portion in the passage section 46 of the duct part 44 is constituted of a part of a side section (left section 20b in the illustrated embodiment) of the housing 12, and the other side portion is arranged parallel to the side portion of the housing 12 at a position away from the side portion toward the outer side. The end portions of the duct part 44 in the longitudinal direction extend from the front section 20a and the rear section 20c of the housing 12, respectively. An opening is defined on a side section (left section 20b) of the housing 12, and the inner opening section 45 of the duct part 44 is arranged in conformity with the opening.

In FIG. 7, the duct part 44 is configured to extend in the front-rear direction along the side surface of the housing 12 in the left-right direction, but the duct part 44 may be configured to extend in the left-right direction along the side surface of the housing 12 in the front-rear direction.

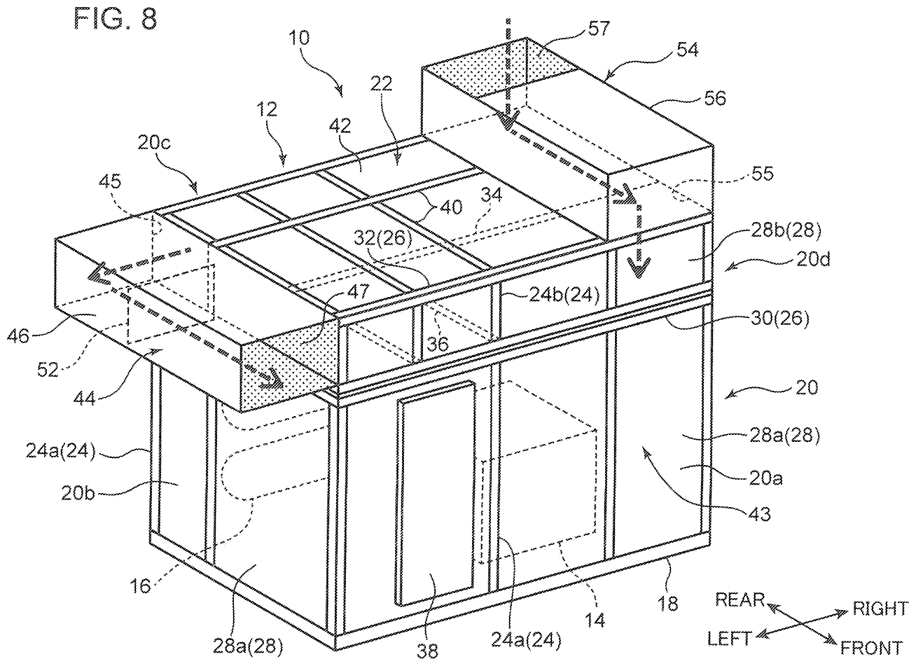

Although the duct part 44 in FIG. 7 shows an example in which the outer opening section 47 opens upward, the outer opening section 47 may open horizontally as shown in FIG. 8.

In the embodiment, the duct part 44 is arranged along a connection portion between the ceiling 22 and the side section of the housing 12, but is not limited thereto. For example, the duct part 44 may be arranged at a position away from the connection portion in a horizontal direction toward the inner side of the housing 12. in this case, the outer side portion of the duct part. 44 is not constituted by the side section of the housing 12 but is constituted by a wall body provided in the housing 12.

In the embodiment, the duct part 44 and the second duct part 54 are formed in a shape extending in the front-rear direction, but are not limited thereto. The duct part 44 and the second duct part 54 may be formed in a shape extending in the left-right direction. In this case, the duct part 44 and the second duct part 54 may be formed to have a length extending from the left section 20b to the right section 20d of the housing 12, or may be shorter than the length.

Here, the above-described embodiment is outlined.

(1) The gas supply apparatus according to the embodiment is to be installed in a site of a facility for replenishing hydrogen gas. The gas supply apparatus comprises: a gas treatment unit for treating the hydrogen gas; a housing including a gas unit accommodation part for accommodating the gas treatment unit; and a duct part for allowing the air to flow out or into the gas unit accommodation part. The housing includes a side section and a top section each having a barrier member. The duct part includes an inner opening section opened horizontally to the gas unit accommodation part, a passage section joining the inner opening section, and an outer opening section causing the passage section to open to an outside of the housing. The duct part has a barrier member.

In the embodiment, both the gas unit accommodation part and the duct part have a barrier member to have a configuration where both explosion-proof and explosion venting can be achieved. In addition, since the inner opening section opens horizontally, it is possible to suppress generation of gas retention in the gas unit accommodation part.

(2) The duct part may be provided in an inside of the housing. In this embodiment, the gas supply apparatus can be made compact. Since a projection is not defined on the rooftop, the space on the top section of the housing can be effectively utilized.

(3) The passage section may extend in a direction different from an opening direction of the inner opening section. In this embodiment, even if the length of the duct part is shortened, the gas treatment unit can be hardly seen through the outer opening section.

(4) The outer opening section may open upward in the top section of the housing, or may open horizontally in the side section of the housing. In this embodiment, since the duct part does not project from the top section or the side sections of the housing, the dimensions in the height direction or the lateral direction of the housing can be suppressed.

(5) The duct part may be provided adjacent to the side section of the housing. In this case, the outer opening section may open upward or horizontally. In this embodiment, since the duct part is adjacent to the housing and is not limited to the dimensions of the housing, the outer opening section can be formed to be larger.

(6) The gas treatment unit may be hidden by the duct part to be invisible from outside through the outer opening section. In this embodiment, the whole gas treatment unit is shielded from the site boundary, so that the configuration is in conformity with The General High Pressure Gas Safety Ordinance.

(7) The gas supply apparatus may further include another duct part arranged on the top section of the housing. In this case, the another duct part may include an inner opening section opened downward to the gas unit accommodation part, an outer opening section opened upward, and a passage section connecting the inner opening section and the outer opening section. The another duct part may have a harrier member.

(8) The gas treatment unit may be hidden by the another duct part to be invisible from outside through the outer opening section. In this embodiment, the whole gas treatment unit is shielded from the site boundary, so that the configuration is in conformity with The General High Pressure Gas Safety Ordinance.

As described above, it is possible to provide a gas supply apparatus having a configuration which makes it possible to vent explosion while preventing the cost required for a barrier structure from becoming excessive.

This application is based on Japanese Patent Application No. 2020-134474 filed on Aug. 7, 2020, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A gas supply apparatus to be installed in a site of a facility for replenishing hydrogen gas, comprising:
a gas treatment unit for treating the hydrogen gas;
a housing including a gas unit accommodation part for accommodating the gas treatment unit: and
a duct part for allowing the air to flow out of or into the gas unit accommodation part, wherein
the housing includes a side section and a top section each having a barrier member, and
the duct part includes an inner opening section opened horizontally to the gas unit accommodation part, a passage section joining the inner opening section, and an outer opening section causing the passage section to open to an outside of the housing, and the duct part has a barrier member.

2. The gas supply apparatus according to claim 1, wherein
the duct part is provided in an inside of the housing.

3. The gas supply apparatus according to claim 2, wherein
the passage section extends in a direction different from an opening direction of the inner opening section.

4. The gas supply apparatus according to claim 2, wherein
the outer opening section opens upward in the top section of the housing, or opens horizontally in the side section of the housing.

5. The gas supply apparatus according to claim 1, wherein
the duct part is provided adjacent to the side section of the housing, and
the outer opening section opens upward or horizontally.

6. The gas supply apparatus according to claim 1, wherein
the gas treatment unit is hidden by the duct part to be invisible from outside through the outer opening section.

7. The gas supply apparatus according to claim 1, further comprising:
another duct part arranged on the top section of the housing, wherein
the another duct part includes an inner opening section opened downward to the gas unit accommodation part, an outer opening section opened upward, and a passage section connecting the inner opening section and the outer opening section, and the another duct part has a barrier member.

8. The gas supply apparatus according to claim 7, wherein
the gas treatment unit is hidden by the another duct part to be invisible from outside through the outer opening section of the another duct part.
